(19) United States
(12) Patent Application Publication
(10) Pub. No.: US 2011/0132978 A1
(43) Pub. Date: Jun. 9, 2011

(54) FOLDING BOX

(76) Inventor: Rogério Luiz de Sousa, Florianopolis (BR)

(21) Appl. No.: 12/758,095

(22) Filed: Apr. 12, 2010

(30) Foreign Application Priority Data
Dec. 7, 2009 (BR) 017090001882

(51) Int. Cl. B65D 5/00; B31B 1/26

(52) U.S. Cl. 229/117.13; 493/162

(57) ABSTRACT

A foldable box manufactured from one sheet of paper or cardboard, the sheet cut and shaped to be easily foldable and collapsible for storage and stacking.

### FIELD OF THE INVENTION

This invention refers to foldable and collapsible paper and/or cardboard assembled box with quickly assembling and folding method.

### BACKGROUND OF THE INVENTION

The currently cardboard boxes are cut in special format so as its parts fit together to obtain its final format for objects and/or products transportation and/or packaging. Such boxes should be store in a way to save space, then they shall be totally disassembled, therefore, the user should assemble them prior to use; and some time and technique are required for the perfect assembly by the final user. This makes difficulty the storage if the fast use need exists or they should be available for people, which are not familiar with the assembly.

The folding box of the present invention was developed to solve such assembly and storage issue, which allows the immediate use from inventory. The assembling and folding method of the present invention is fast and easy, with a great advantage for stacking and storing the collapsed and folded boxes.

### SUMMARY OF THE INVENTION

The present invention seeks to provide a 1. a foldable box comprising: (a) a rectangular bottom part, having two shorter edges and two longer edges; (b) two opposite rectangular shorter sides attached to the shorter edge of the bottom part, each side having two opposite triangle flaps A with multiple perforation lines P2; the sides further and including an opening C defining a handle; (c) reinforcements R adjacent to each shorter side, the reinforcements R including openings C2, symmetrical to openings C, defining a symmetrical handle, and (d) two opposite rectangular longer sides L2 attached to the longer edges of the bottom part, each side having two opposite diagonal perforation lines P1, forming triangular opposite flaps O.

The present invention also seeks to provide a method of assembling the foldable box, the method comprising the steps of: (a) folding the shorter sides, towards the inside of the box, in parallel to each other and perpendicular to the bottom part; (b) folding the two opposite triangle flaps A, towards the inside of the box, in parallel to each other and perpendicular to the bottom part; (c) folding the longer sides L2, in parallel, towards the inside of the box; (d) gluing the triangular opposite flaps O of the longer sides L2 to the opposite triangle flaps A; (e) folding reinforcements R is also folded towards the inside of the box, and (f) gluing the reinforcement R to the shorter sides, defining the handle.

The present invention further seeking to provide a folding method for the assembled foldable box of, the method comprising the steps of: (a) folding the longer sides, towards the inside of the box, in parallel to each other and in parallel to the bottom, and (b) folding the shorter sides, towards the inside of the box, in parallel to each other and in parallel to the bottom; the box then staying in a collapsed position.

### BRIEF DESCRIPTION OF THE DRAWINGS

FIG. 1 shows the cut of the ground plan drawing of the box.

FIG. 2 shows the assembling and gluing of the box.

FIG. 3 shows the folding and collapsing of the box for storage and stacking.

FIG. 4 is a short side view of the assembled box

FIG. 5 is a long side view of a partially assembled box

FIG. 6 is a long side view of a completely assembled box

FIG. 7 shows an assembled box collapsed and closed and ready for storage and stacking.

FIG. 8 shows an assembled box unfolded, opened and ready for use.

### DETAILED DESCRIPTION OF THE INVENTION

The invention will be described for the purposes of illustration only in connection with certain embodiments; however, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

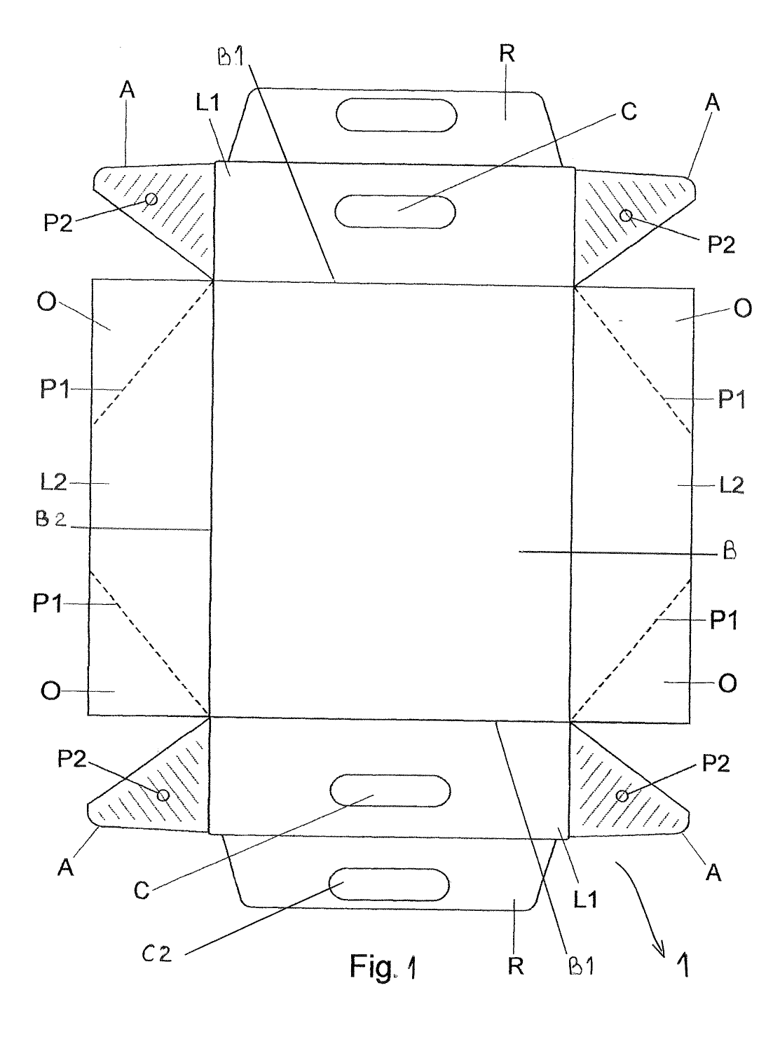

The box are manufactured from one sheet of paper/cardboard according FIG. 1. The sheet is cut and shaped to be easily foldable.

As it can be seen from the figures, rectangular foldable box 1 has a rectangular bottom part B, having a shorter edge B1 and a longer edge B2, two rectangular shorter sides L1 and two rectangular longer sides L2. Rectangular shorter sides L1 have first opposite triangle flaps A with multiple perforation lines P2 on each side. The perforated flaps enable a stronger gluing in the flaps. Shorter sides L1 also include opening C defining a handle. Reinforcements R are adjacent to shorter sides L1 (FIGS. 1, 4 and 5), the reinforcements R including openings C2, symmetrical to opening C and defining a symmetrical handle with opening C.

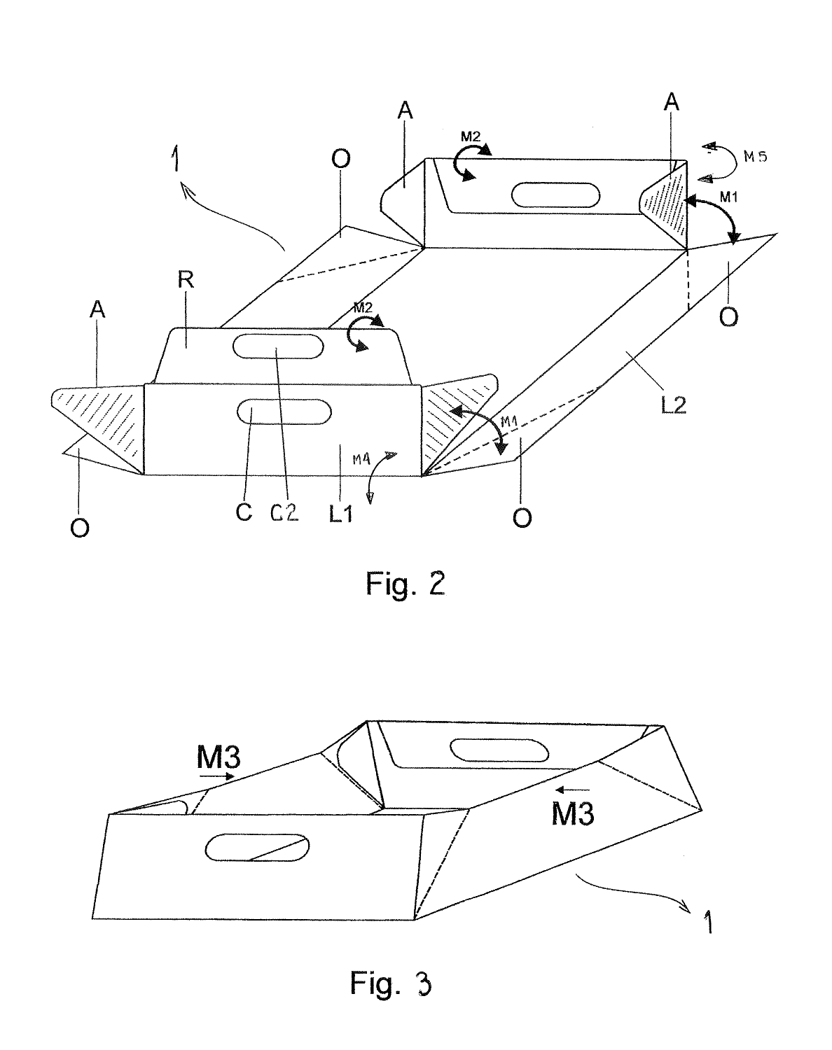

Longer sides L2 have opposite diagonal perforation lines P1 forming second opposite triangular flaps O. These flaps making easier the folding (FIGS. 2 and 3) of the box.

When folding the box, shorter sides L1 are folded towards the inside of the box by movement M4, in parallel to each other and perpendicular to the bottom part, and the first opposite triangle flaps A are further folded towards the inside of the box, movement M5. Longer sides L2 are then folded towards the inside of the box, in parallel to each other and perpendicular to the bottom part, and glued on the outside of flaps A, the flaps A staying in the inside of the flaps O, according to movement M1 in FIG. 2. Reinforcements R are also folded towards the inside of the box and openings C and C2 are matched and glued according to movement M2 in FIG. 2.

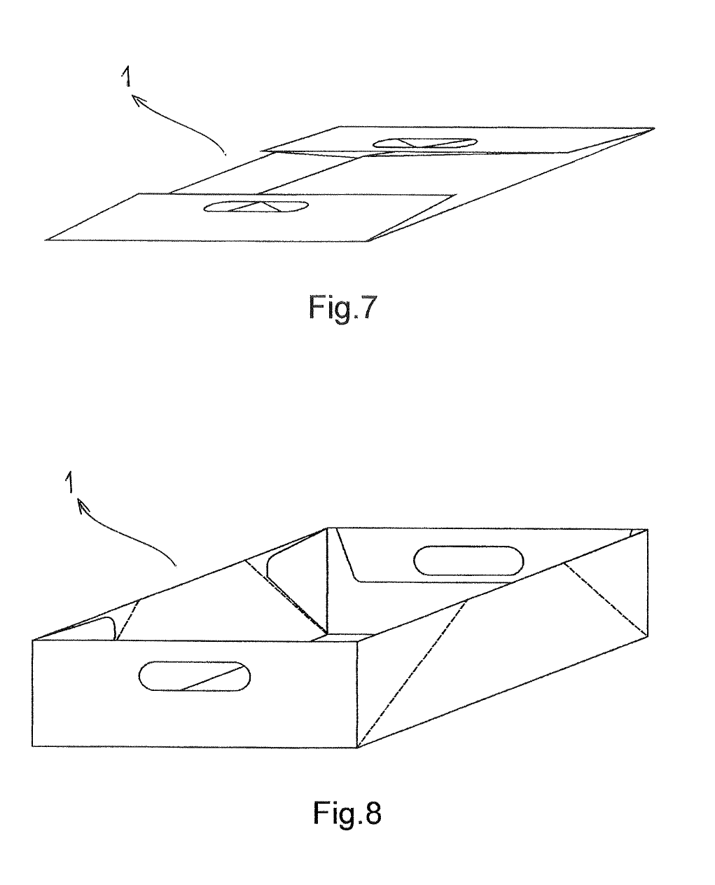

The boxes glued at the manufacturer are ready to be folded when arriving at the final user. The boxes are closed according to movement M3 represented in FIG. 3. and The folded box can be seen as illustrated in FIG. 7 and the same box can be seen open in FIG. 8. In open position, FIG. 8, the box is ready for use with any products and/or objects transportation and/or storage. If customer intends to keep the box after the use, he/she just push the L2 largest sides according to movement M3 in FIG. 3, and returns to the format at FIG. 7, and this procedure could be repeated to open and close the box as many times customers considers necessary.

The folding boxes require small spaces and are pile up for storage and the space used is of the same size of its ground plan drawing showed under FIG. 1. This a great advantage over the traditional boxes that require more space when opened as their walls are opened. Therefore, it saves space and is very practical to store them and arrange them to be available to customers in stores, supermarkets, and any other facility or place where it is used.

First opposite triangle flaps A contain multiple perforation lines P2 that enable more efficient gluing of second opposite triangular flaps O and allows more cargo capacity to the box. In addition to such property the box has the reinforcements R including opening C2, symmetrical to opening C defining a symmetrical handle which ensures the strength to the assembly.

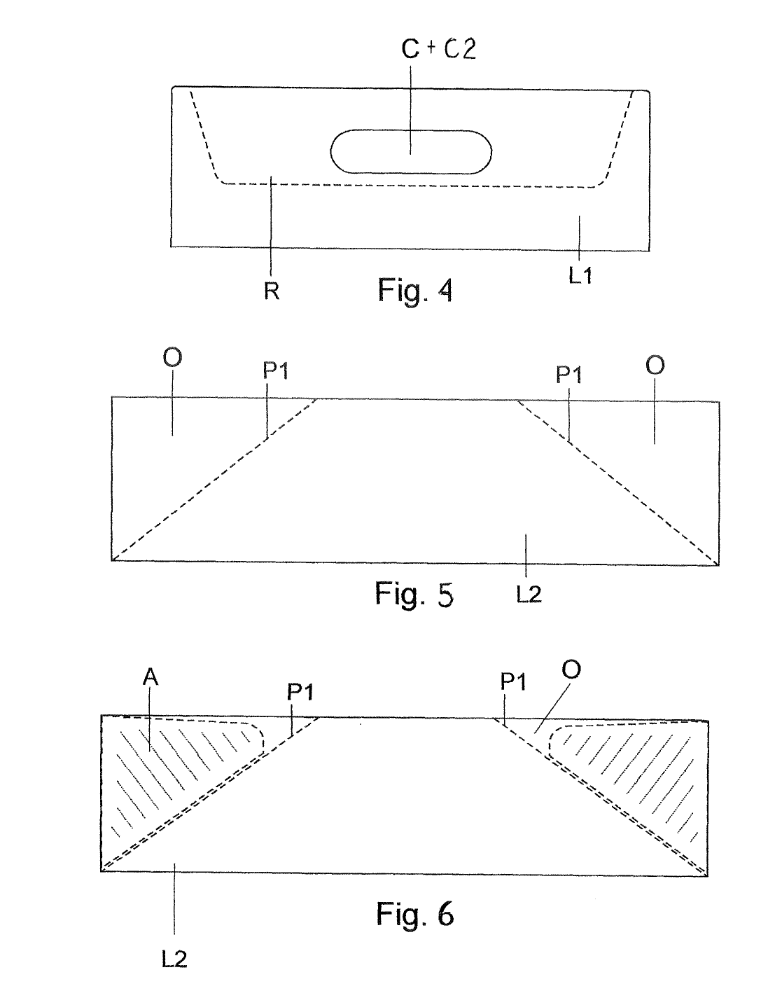

In FIG. 4 the assembled box can be seen from the shorter side. The shorter side L1 with defined handle C and the reinforcement R including opening C2, symmetrical to opening C defining a symmetrical handle C+C2.

In FIG. 5 the assembled box is seen from the longer side, where longer side L2 side has opposite diagonal perforation lines P1 and second opposite triangular flaps O.

The longer side of the box can also be seen in FIG. 6 where the internal position of second opposite triangular flaps O are already glued to the longer side L2;

In FIG. 2 the assembling of the box can be seen. Shorter side L1 is folded towards the inside of the box, in parallel to each other and perpendicular to the bottom part, by movement M4, folding the shorter sides, towards the inside of the box, in parallel to each other and perpendicular to the bottom part. Flaps A with multiple perforation lines P2 are further folded towards the inside of the box, now by movement M5, and glued on the inside of second opposite triangular flaps O, by folding the longer side L2 towards the inside of the box, now by movement M1, the flaps A staying in the inside of the flaps O, when the box is assembled. Then, by movement M2, reinforcements R is also folded towards the inside of the box and gluing the reinforcements R including opening C2 to shorter side L1 defining handle C+C2.

In FIG. 3 can be seen how the assembled box, already glued and ready for storage, is closed by performing movement M3, which will fold the sides towards the inside of the box, in parallel to each other and perpendicular to the bottom part. By performing movement M3, the box will collapse and may be stored and stacked. In FIG. 7 the collapsed box (in the closed position) is seen, and in FIG. 8 the box unfolded, opened and ready for use.

1. A foldable box comprising:
(a) a rectangular bottom part, having two shorter edges and two longer edges;
(b) two opposite rectangular shorter sides attached to the shorter edge of the bottom part, each side having two opposite triangle flaps A with multiple perforation lines P2; the sides further and including an opening C defining a handle;
(c) reinforcements R adjacent to each shorter side, the reinforcements R including openings C2, symmetrical to openings C, defining a symmetrical handle, and
(d) two opposite rectangular longer sides L2 attached to the longer edges of the bottom part, each side having two opposite diagonal perforation lines P1, forming triangular opposite flaps O

2. A method of assembling the foldable box of claim 1, the method comprising the steps of:
(1) folding the shorter sides, towards the inside of the box, in parallel to each other and perpendicular to the bottom part;
(2) folding the two opposite triangle flaps A, towards the inside of the box, in parallel to each other and perpendicular to the bottom part;
(3) folding the longer sides L2, in parallel, towards the inside of the box;
(4) gluing the triangular opposite flaps O of the longer sides L2 to the opposite triangle flaps A;
(5) folding reinforcements R is also folded towards the inside of the box, and
(6) gluing the reinforcement R to the shorter sides, defining the handle.

3. The method of folding the assembled foldable box of claim 2, the method comprising the steps of:
(i) folding the longer sides, towards the inside of the box, in parallel to each other and in parallel to the bottom, and
(ii) folding the shorter sides, towards the inside of the box, in parallel to each other and in parallel to the bottom;
wherein the box is in a collapsed position.

4. The method of folding the assembled foldable box according to claim 3, the method further comprising the step of stacking the de collapsed folded assembled box.
